(19) United States
(12) Patent Application Publication
(10) Pub. No.: US 2013/0190990 A1
(43) Pub. Date: Jul. 25, 2013

(54) SAFETY INTEGRATED SEATING SYSTEMS

(71) Applicant: Raf Haidar, Coventry (GB)

(72) Inventor: Raf Haidar, Coventry (GB)

(73) Assignee: CVG MANAGEMENT CORPORATION, New Albany, OH (US)

(21) Appl. No.: 13/554,653

(22) Filed: Jul. 20, 2012

Related U.S. Application Data
(60) Provisional application No. 61/509,605, filed on Jul. 20, 2011.
(60) Provisional application No. 61/536,296, filed on Sep. 19, 2011.

(51) Int. Cl. B60R 22/48

(52) U.S. Cl. CPC B60R 22/48
USPC 701/45

(57) ABSTRACT

A safety integrated seating system (SISS) is disclosed and includes a lap belt pretensioner component that simultaneously cinches two portions of a lap belt upon detection of an event and a shoulder belt pretensioner component that simultaneously cinches two shoulder belts upon detection of the event.

### CROSS-REFERENCE TO RELATED APPLICATIONS

This application claims the benefit of U.S. Provisional Patent application Ser. No. 61/509,605 entitled “SAFETY INTEGRATED SEATING SYSTEMS” filed on Jul. 20, 2011 and to U.S. Provisional Patent application Ser. No. 61/536,296 entitled “SAFETY INTEGRATED SEATING SYSTEMS” filed on Sep. 19, 2011. The entireties of the above-noted applications are incorporated by reference herein.

### BACKGROUND

Today, seat belts, also known as safety belts and safety harnesses, are designed to secure a vehicle occupant from harmful movement that may result, e.g., from a collision, sudden stop or other event. The safety belt is often referred to as a part of an overall automobile passive safety system. These belts are used to avoid or alleviate injuries by restraining the occupant from impacting hard surfaces or other objects. Additionally, in today's vehicles, it is important that a safety belt retrains the occupant in a correct anatomical position such that the airbag can deploy and alleviate the occupant (or passenger) from being thrown from or about the vehicle.

Moreover, seat belts can absorb energy by being designed to stretch during sudden deceleration. Thus, they can be designed to provide less speed differential between the passenger's body and the vehicle interior. Further, the seat belt can be designed to distribute the loading of impact on the passenger's body.

Today, many vehicles are equipped with seatbelts having seatbelts with pretensioners. In these systems, upon detection of an “event,” the pretensioner can preemptively tighten the belt to prevent an occupant from lunging forward at risk of hitting an interior component or being ejected from the vehicle. Today, advances in technology enable pretensioners to tighten the belt almost instantaneously in response to a crash. Similar to airbag technology, pretensioners are activated by sensors employed within the car's body. Most pretensioners use explosively expanding gas to drive a piston that retracts the belt upon detection of an event.

Conventional pretensioners, however, are limited in functionality and, thus, what is required is an improved more functional pretensioner system.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a safety integrated seating system (SISS) is disclosed and includes a lap belt pretensioner component that simultaneously cinches two portions of a lap belt upon detection of an event and a shoulder belt pretensioner component that simultaneously cinches two shoulder belts upon detection of the event.

In another aspect of the subject innovation discloses a safety integrated seating system (SISS), comprising a pretensioning system to pretension a seat belt harness upon a detection of an event, a sensing subsystem that detects the event and activates the pretensioning system, a sensor component that senses seat occupancy/seat belt status, a monitoring component that monitors the sensor component to determine seat occupancy/seat belt status, and a notification component that alerts of a disengaged safety belt state when the occupant is seated.

In still another aspect of the innovation, a method of pretensioning a seat belt harness is disclosed and includes detecting an event via a lap belt sensor and/or a shoulder belt sensor, determining if a lap belt pretensioner and/or a shoulder belt pretensioner should be activated, and activating the lap belt pretensioner thereby simultaneously tightening a pair of lap straps and/or the shoulder belt pretensioner thereby simultaneously tightening a pair of shoulder straps, whereby the lap belt pretensioner and the shoulder belt pretensioner can operate independently, dependently or simultaneous.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example block diagram of a safety integrated seating system (SISS) in accordance with aspects of the innovation.

FIG. 2 illustrates an alternative example block diagram of an SISS in accordance with aspects of the innovation.

FIG. 3 illustrates an example flow chart of procedures that facilitate dual pretensioning in accordance with an aspect of the innovation.

FIG. 4 illustrates an example of a shoulder harness (upper) and lap belt (lower) in accordance with aspects of the innovation.

FIG. 5 illustrates an example 4-point harness in accordance with aspects of the innovation.

FIGS. 6-8 illustrate an example lap belt pretensioner in accordance with aspects of the innovation.

FIGS. 9-14 illustrate an example shoulder harness pretensioner strap in accordance with aspects of the innovation.

FIGS. 15 and 16 illustrate another example embodiment of the innovation that employs inflatable belts in accordance with aspects of the innovation.

FIG. 17 illustrates an example 3-point harness in accordance with aspects of the innovation.

FIGS. 18 and 19 illustrate a seat suspension in upper and lower positions and employing a lock plate in accordance with aspects of the innovation.

FIG. 20 illustrates an example block diagram of an alternative system in accordance with aspects of the innovation.

FIG. 21 illustrates example sensor components in accordance with aspects of the innovation.

FIG. 22 illustrates an example rendering and display of a system in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

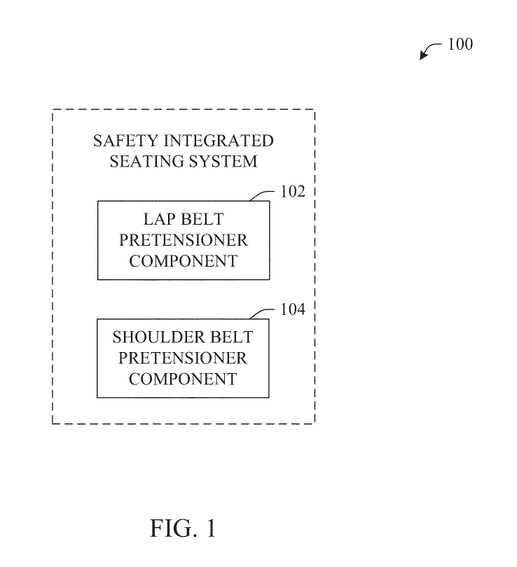

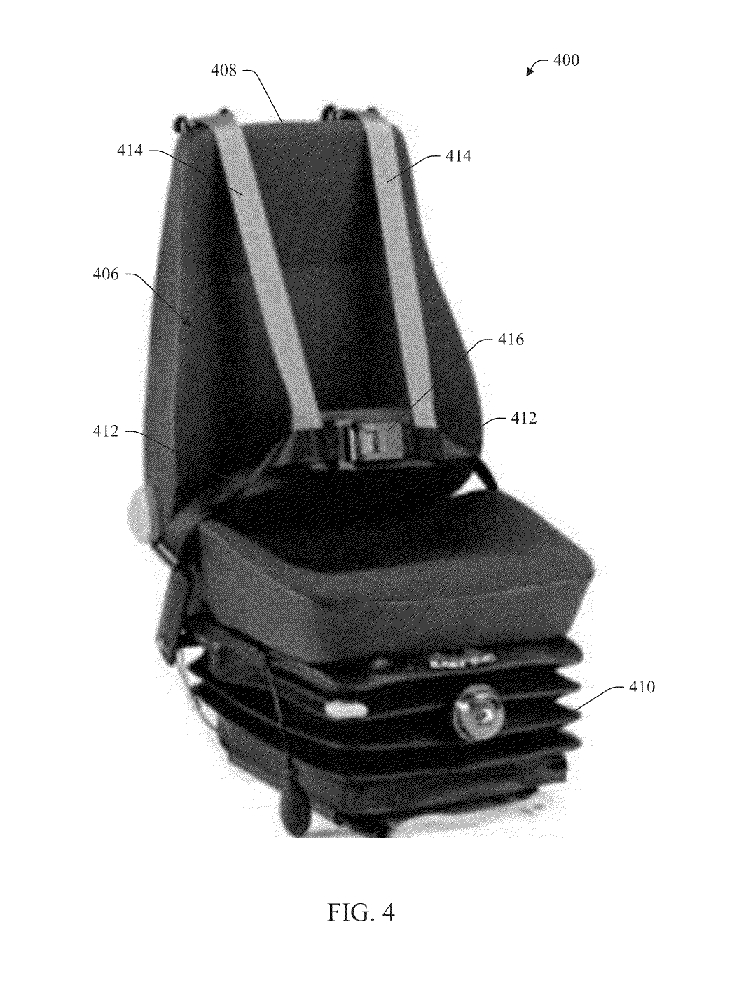

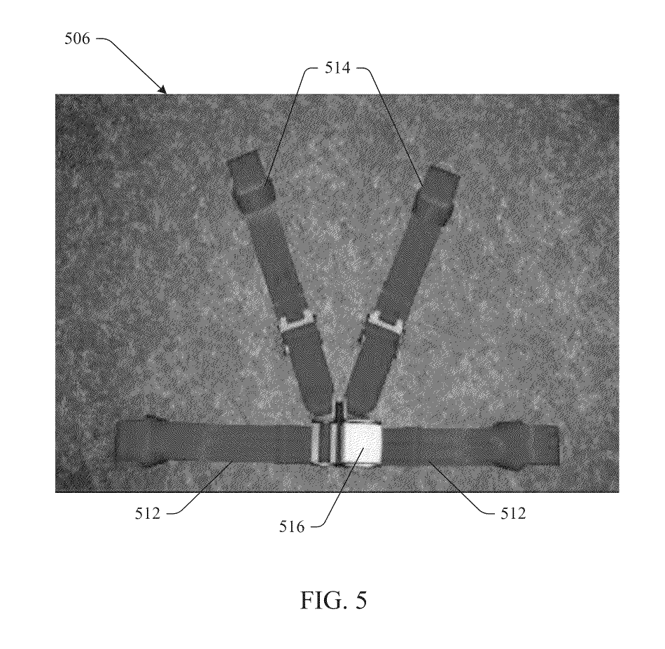

Referring initially to the drawings, FIG. 1 illustrates a safety integrated seating system (SISS) 100 for a vehicle in accordance with aspects of the innovation. As shown, the system 100 can generally include a lap belt pretensioner component 102, a shoulder belt pretensioner component 104, and a multi-point harness (shown in FIGS. 4 and 5 below). In one aspect, a four point harness is employed that is secured behind an occupant's shoulders by a single pretensioner for each the shoulder and lap portions of the harness. In other words, each of the straps that travel over a wearer's shoulders is connected to a single pretensioner component 104 that, when operated, cinches or pretensions each of the shoulder straps simultaneously, as will be described further below. Similarly, the lap belt pretenstioner component 102 is employed to cinch or pretension each of the lap belt portions simultaneously, e.g., in response to a collision or other event. While a four point harness-type restraint is disclosed herein, it is to be understood that the features, functions and benefits of the innovation can be employed in connection with most any restraint without departing from the spirit and/or scope of the innovation and claims appended hereto.

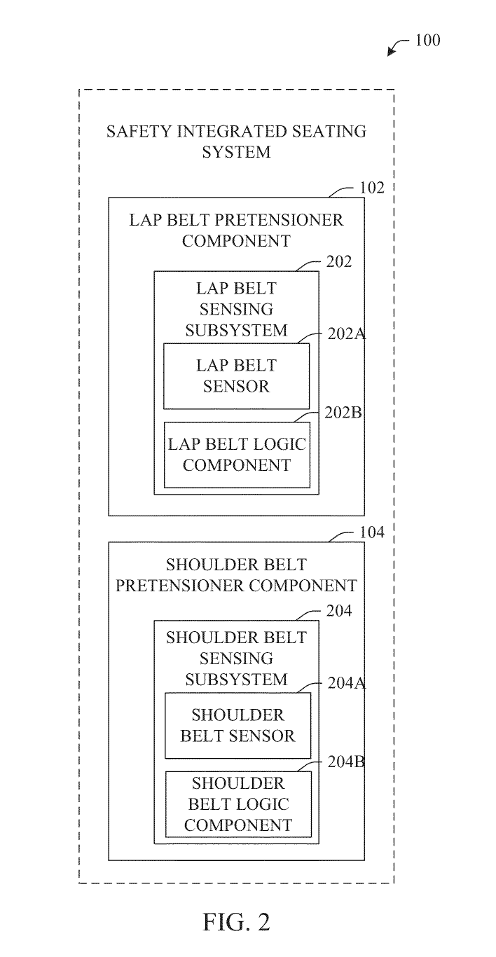

Referring to FIG. 2, each of the lap belt pretensioner component 102 and the shoulder belt pretensioner component 104 employ a lap belt pretensioner sensing subsystem 202 and a shoulder belt pretensioner sensing subsystem 204 respectively. Each sensing subsystem 202, 204 can employ a sensor 202A, 204A, such as but not limited to front sensors, side sensors, rollover sensors, sensors similar those used in airbag technology, etc. or a combination thereof to thereby detect roll rate and/or acceleration. The sensors 202A, 204B are configured to monitor, detect, sense, anticipate, etc. contact by the vehicle with an object, referred to as a collision event or event. Further, each sensing subsystem 202, 204 further includes a logic component 202B, 204B. Each logic component 202B, 204B determines if the respective pretensioner should be activated, as explained below. The benefits of simultaneous tensioning will be understood by those skilled in the art. In other words, the tensioning enables an occupant to adequately maintain a correct anatomical position in the event of a crash thereby reducing the risk of injury to the occupant.

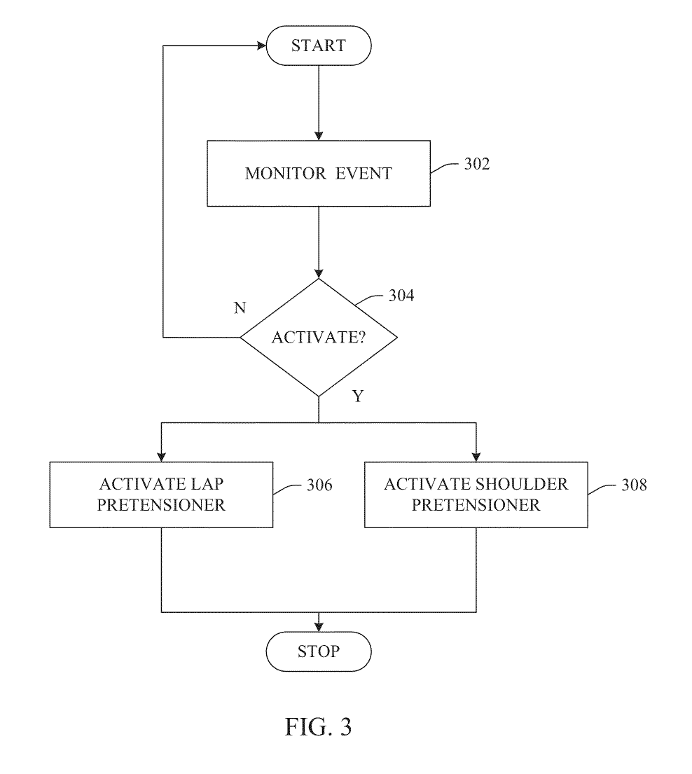

FIG. 3 illustrates a methodology of dual tensioning in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, an event is monitored, detected, sensed or anticipated via one or both of the sensors 202A, 204A. At 304, the logic component 202B, 204B for each pretensioner 102, 104 determines if the respective pretensioner should be activated. For example, if the event exceeds a predefined threshold, the respective logic component 204A, 204B makes the decision to activate the respective pretensioner 102, 104. It is to be understood that there can be more than one threshold value whereby one or both pretensioners 102, 104 can be activated. Thus, the pretensioners 102, 104 can have multiple modes of operation. For example, the pretensioners 102, 104 can be activated independently of each other or be activated dependent of one another where when one pretensioner activates the other automatically activates. In another embodiment, the pretensioners 102, 104 can activate simultaneously. One advantage to activating the pretensioners simultaneously is that an occupant's position can be correctly maintained in a collision by the tensioning of each of the shoulder straps as well as each portion of the lap belts. Once the decision to activate the pretensioners 102, 104 is made, the lap pretensioner 102 and/or the shoulder pretensioner 104 are activated at 306 and 308 respectively.

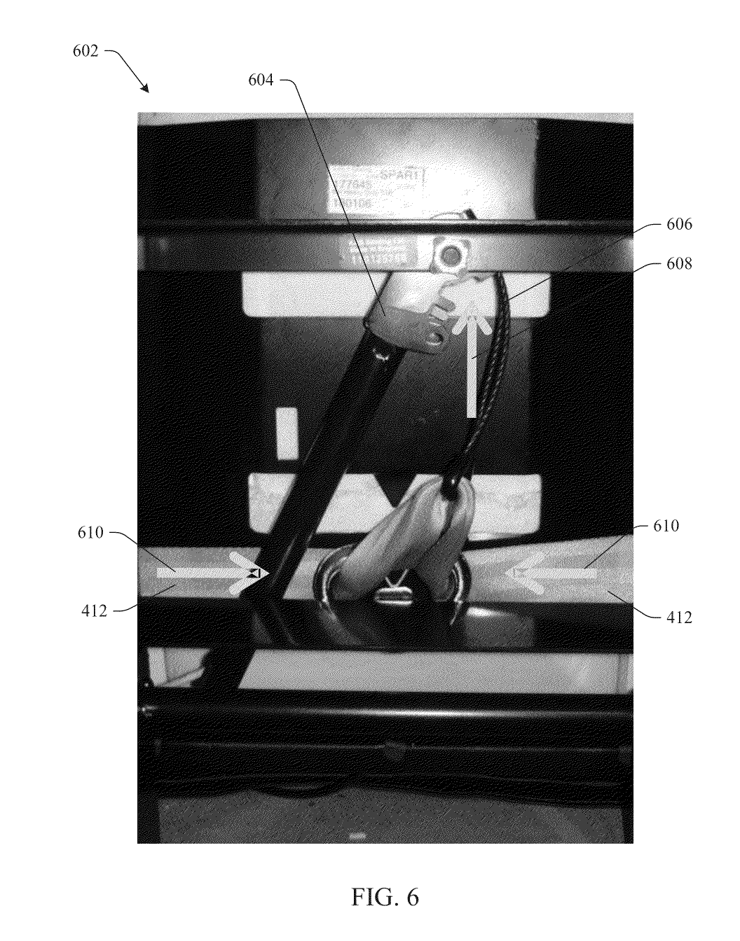

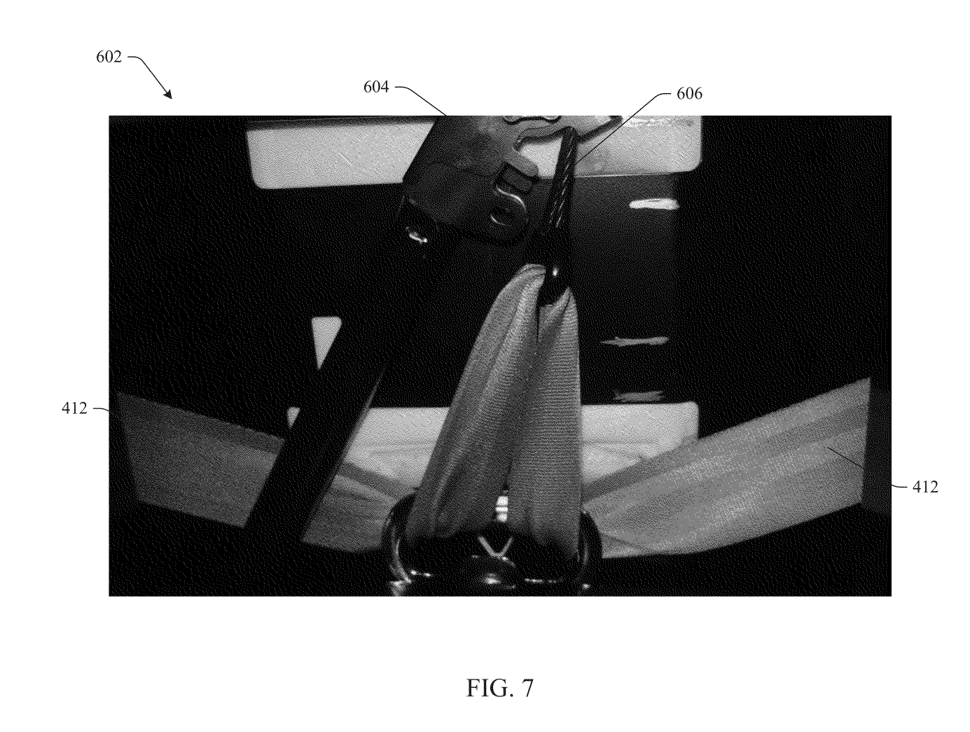

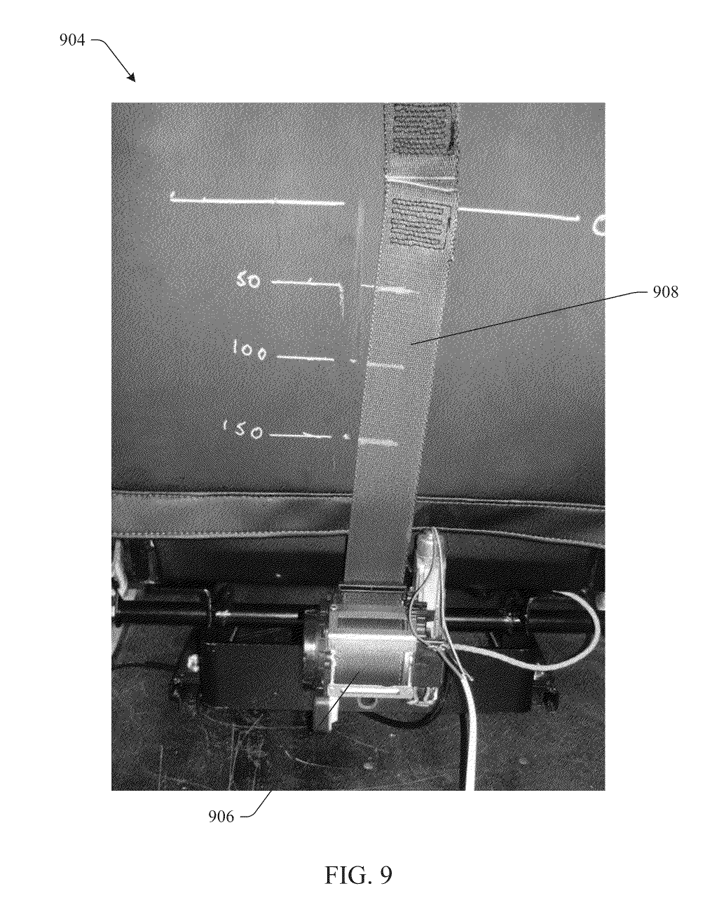

FIG. 4 is an illustration of a seat assembly 400 that includes a lap belt pretensioner, see FIGS. 6-7 and the description further below, a shoulder belt pretensioner, see FIGS. 9-11 and the description further below, and an example multi-point harness 406 all of which are attached to a seat 408 and/or a seat frame/base 410. The example multi-point harness 406 illustrated in FIG. 4 is a four-point harness and includes a pair of lap (or horizontal) straps (belts) 412, a pair of shoulder (or vertical) straps (belts) 414, which are essentially perpendicular to the lap straps 412, and a locking device 416 that locks and secures the lap straps 412 and the shoulder straps 414 in place. Upon the detection of an event, the pair of lap straps 412 can be tensioned simultaneously. Similarly, the pair of shoulder straps 414 can also be tensioned simultaneously.

FIG. 5 is an illustration of another example four-point harness 506 that includes a pair of lap straps 512, a pair of shoulder straps 514, and a locking device 516 that locks and secures the lap straps 512 and the shoulder straps 514 in place. In this example embodiment, the shoulder straps 514 are angled with respect to the lap straps 512. The harness 506, however, operates in the same way as the example harness 406 shown in FIG. 4.

Referring now to FIG. 6, the lap belt pretensioner 602 is disposed rearward of the seat assembly 400 shown in FIG. 4 and includes a tensioning device 604 and a tensioning cable 606 that connects the tensioning device 604 to the lap straps 412 that extend around to the rear of the seat assembly 400. When the tensioning device 604 activates, the cable 606 moves in a tensioning direction as indicated by the arrow 608. This in turn causes the lap straps 412 to cinch inward, as indicated by the arrows 610, thereby causing the lap straps 412 to tighten about the occupant. FIG. 7 illustrates a close-up view of the lap belt pretensioner 602 in a tensioned position.

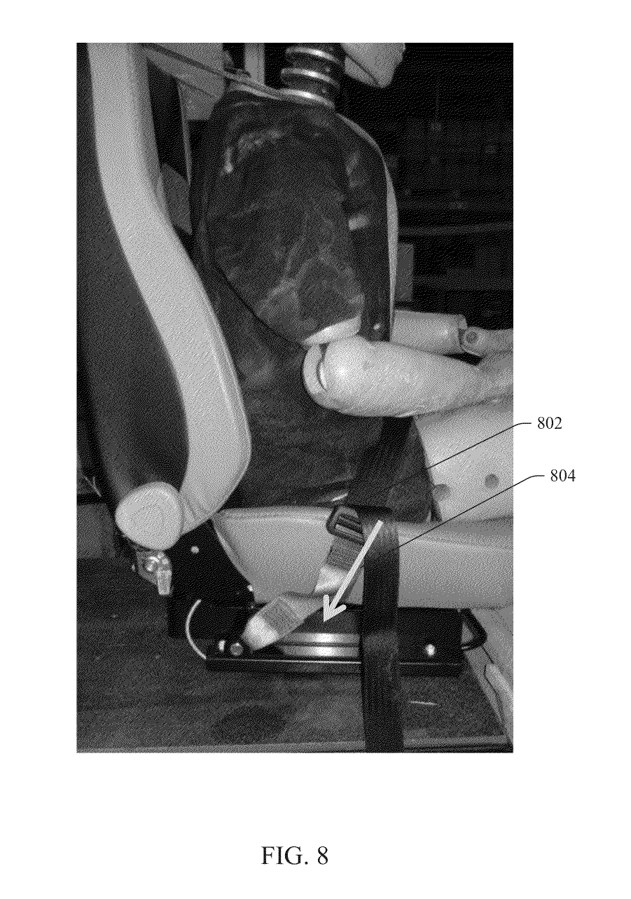

FIG. 8 illustrates another embodiment of a lap strap 802 whereby upon activation of the lap belt pretensioner, the lap strap 802 moves in a downward direction, as indicated by the arrow 804.

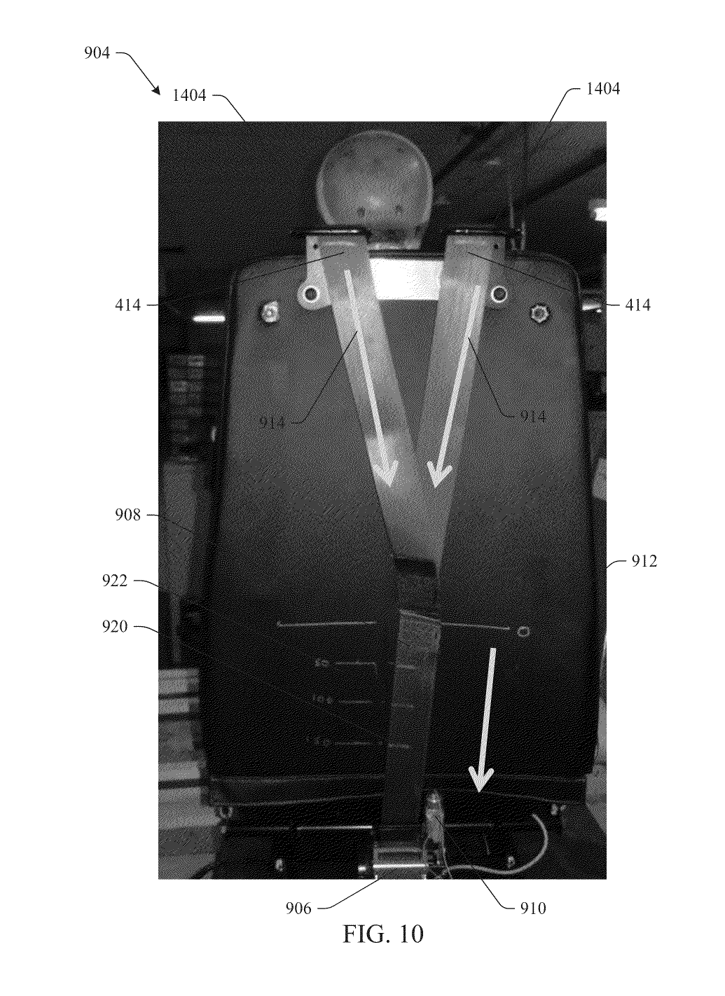

Referring now to FIGS. 9 and 10, the shoulder belt tensioner 904 is also disposed rearward of the seat assembly 400 shown in FIG. 4 and includes a tensioning device 906, such as but not limited to a retractor, and a tensioning strap 908 that connects the tensioning device 906 to the shoulder straps 414, which extend over a top portion of the seat. Activation of the tensioning device 906 is facilitated by a pyrotechnic tube 910. It is to be appreciated, however, that other means can be used to activate both the lap and the shoulder belt pretensioners.

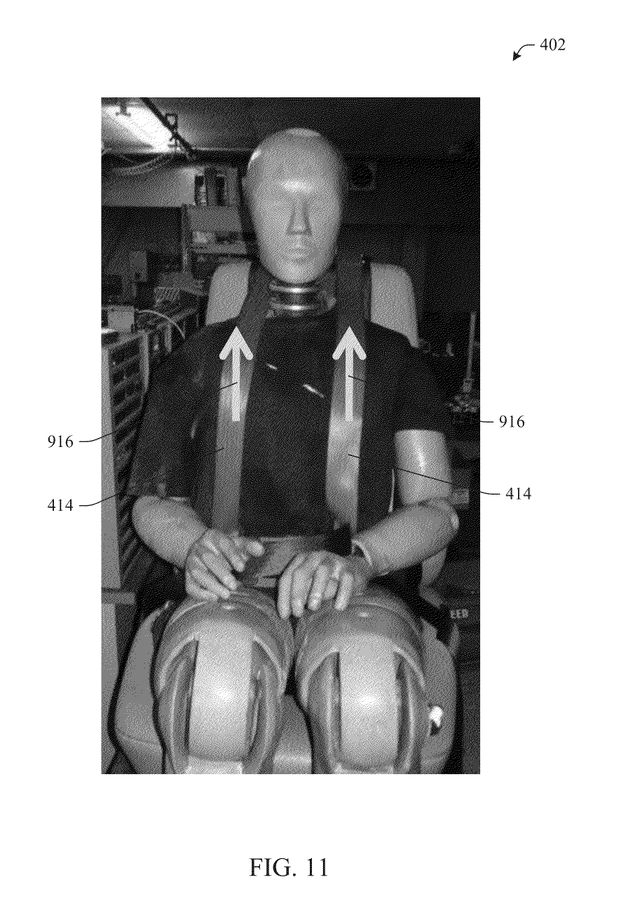

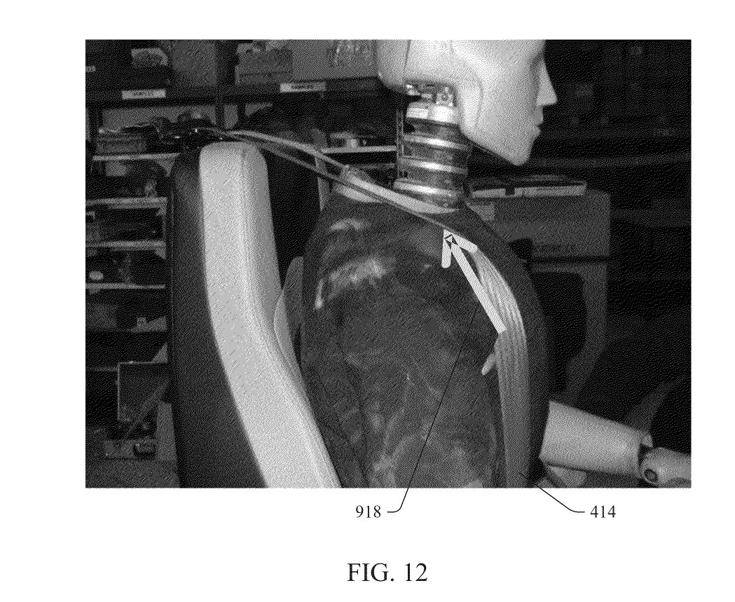

Referring to FIG. 10, as the tensioning device 906 retracts, the tensioning strap 908 moves in a tensioning direction, as indicated by the arrow 912. In turn, the shoulder straps 414 extending over the top of the seat also move simultaneously in the tensioning direction as indicated by the arrows 914. As such, the shoulder straps 414 harnessing the occupant move in the tensioning direction as indicated by the arrows 916 in FIG. 11 thereby tightening the shoulder straps 414 about the occupant. As will be understood, the simultaneous tensioning causing the belts to remain in a suitable location upon the occupant's or wearer's body (e.g., thorax) thereby enhancing protection and operation of the restraint system. FIG. 12 illustrates the movement from a side view of the shoulder strap 414 as indicated by the arrow 918.

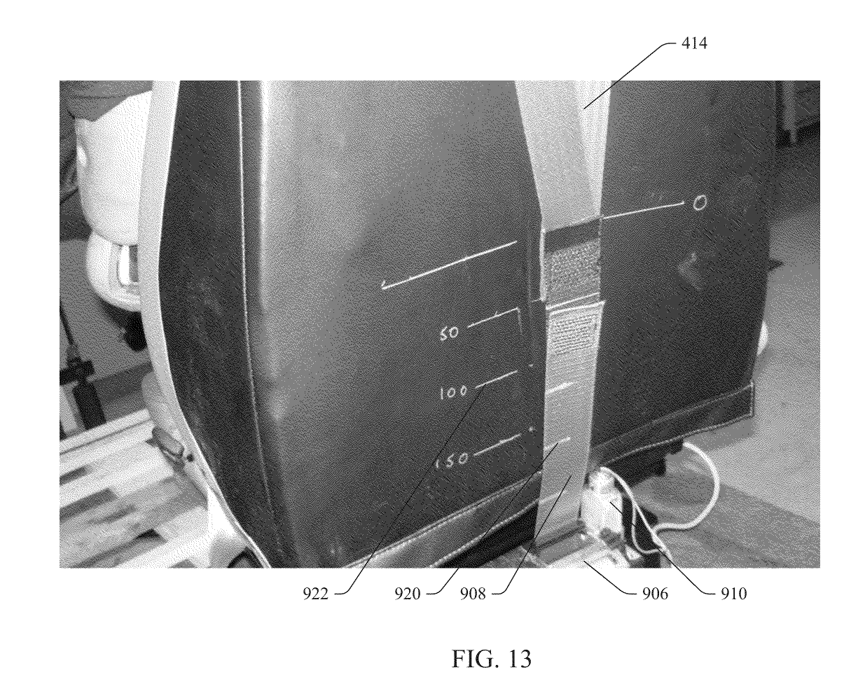

FIG. 13 is an example illustration depicting the amount of movement that the shoulder straps 414 travel when the shoulder belt pretensioner is activated. Referring back to FIG. 10, the shoulder pretensioner 906 is in a non-activated state, thus, the markings 920 on the tension belt are aligned with the markings 922 on the rear of the seat. When the shoulder pretensioner 904 is activated, the tensioning strap 908 and hence the shoulder straps 414 travel approximately 74 mm (70 mm of the lap pretensioner), as indicated by the misalignment of the markings 920, 922. It is to be appreciated that this movement is an example and that the actual movement may vary depending the application.

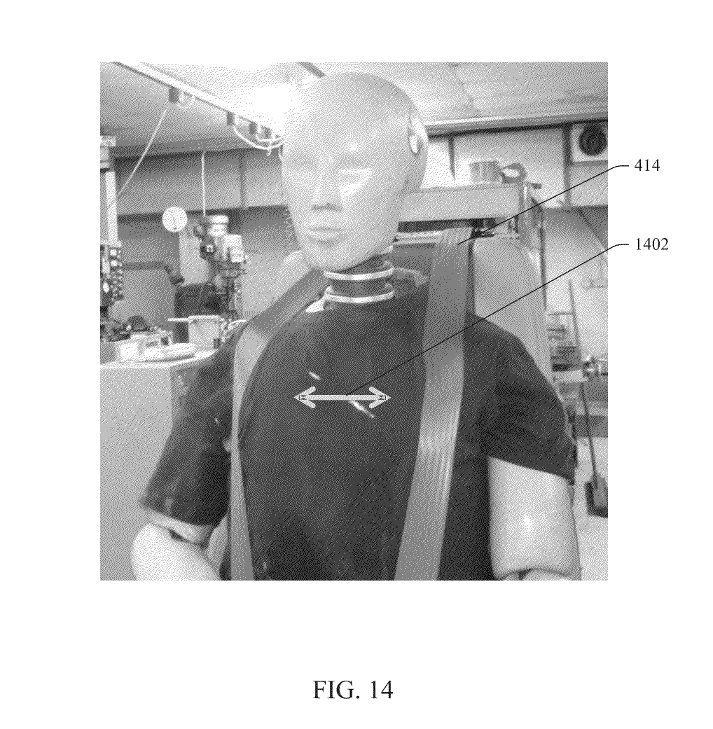

FIG. 14 is an illustration of shoulder straps 414 that are not properly placed on the occupant. Thus, in the event of a collision and without the pretensioning system disclosed herein, the occupant can suffer injuries due to poor strap alignment. In other words, the shoulder straps 414 can shift in the direction of the arrow 1402, which could cause injuries to the occupant in the event of a collision. It will be appreciated that the subject innovation can address or alleviate this concern. Further, upper anchorage guides 1404, see FIG. 10, can be provided to maintain the shoulder straps on the thorax of the wearer. Still further, buckle/tongue fixing positions for the shoulder belts are desired to be centrally located to ensure the shoulder belts do not slip off during a roll-over event.

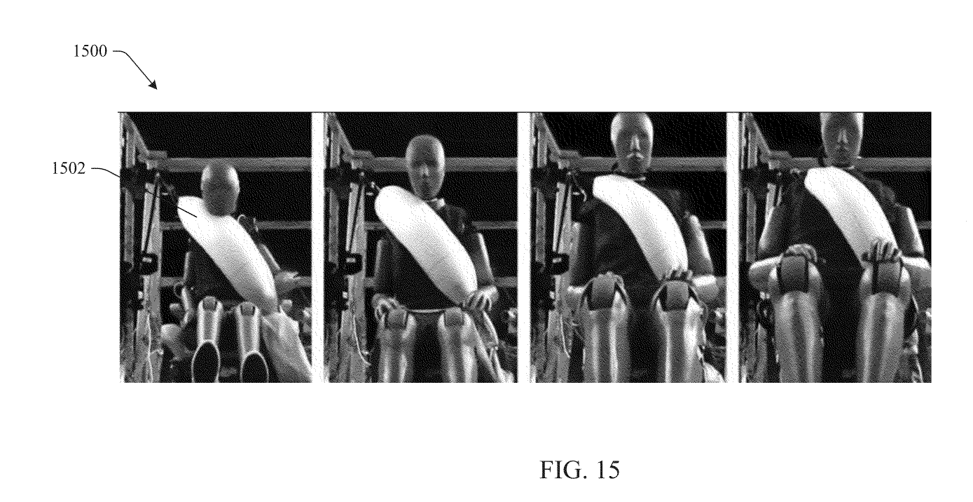

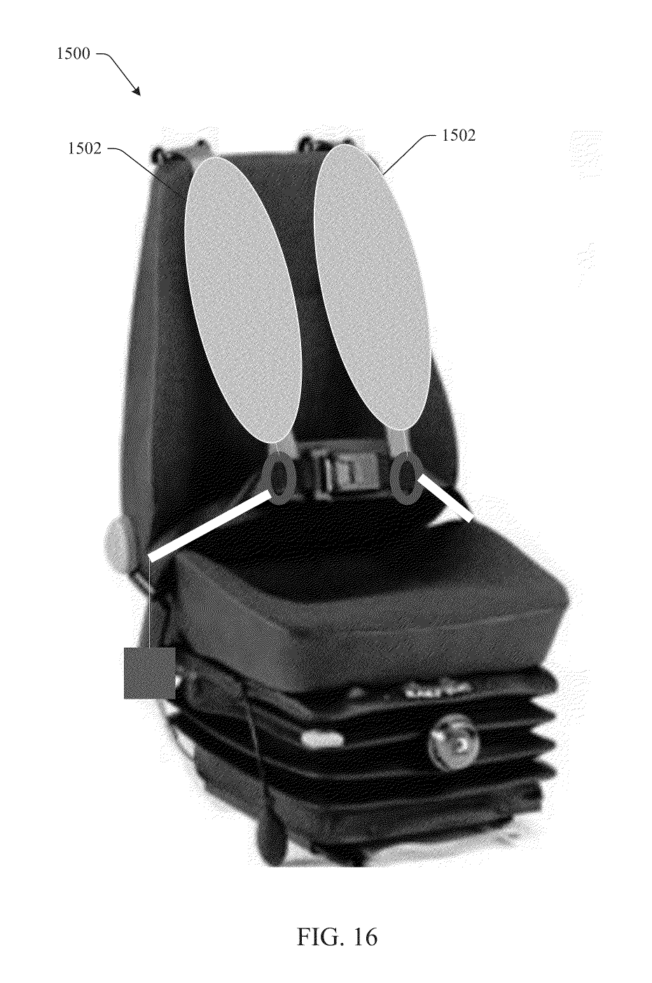

FIGS. 15 and 16 illustrate another embodiment of the innovation that employs an inflatable belt 1500. For example, the shoulder strap and/or the lap strap can be equipped with inflatable bags 1502 that can enhance protection of a wearer. The inflatable bag 1502 can be utilized on a single shoulder strap (three-point) arrangement, as shown in FIG. 15 or on a double strap (four-point) arrangement, as shown in FIG. 16.

In one embodiment, the inflatable airbag(s) 1502 can be Pa 6.6 470 dtex type and can be inflated by a 100 KPa cold gas inflator. The inflatable airbag(s) 1502 can be configured for on and off road applications and can be integrated into the seat assembly and provide protection for frontal, side, and rollover crashes and hypertensions thereby reducing the need for frontal and side airbags. It is to be understood and appreciated that the embodiment of the inflatable bag(s) 1502 and the specific description of some of the features are included to provide perspective to the innovation and is not intended to limit the scope in any manner.

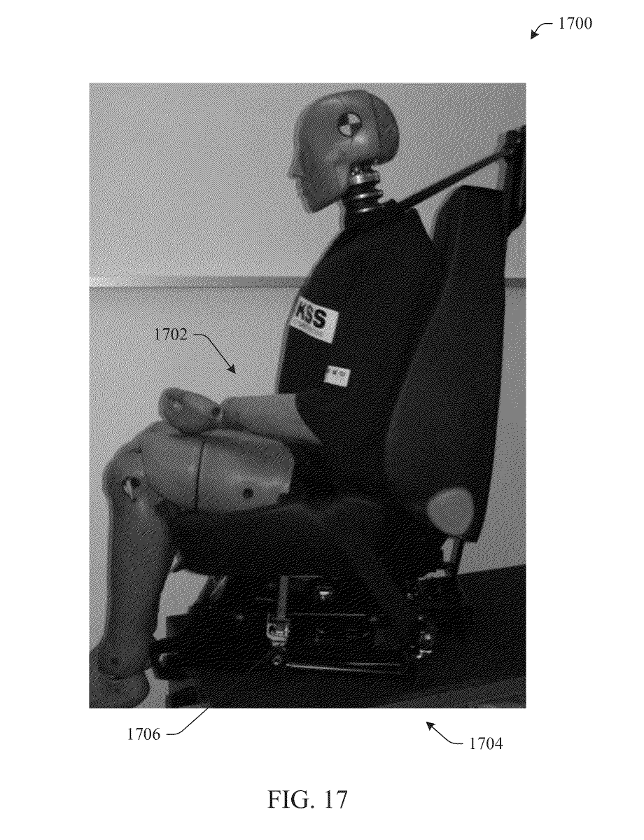

FIG. 17 illustrates yet another example embodiment of a seat assembly 1700 employing the innovation. The seat assembly 1700 includes a three point harness 1702 employing a lap belt pretensioner similar to the lap belt pretensioner described above, a seat suspension 1704, and a suspension lockout 1706. In accordance with the innovation, it will be appreciated that dual pre-tensioning can secure a dummy (or occupant) better than single pyro retractor. Lap pre-tensioning can ensure that the buckle/tongue remain over the pelvis & femurs rather than being pulled up in to the rib cage as is commonplace from single retractor pretensioner systems.

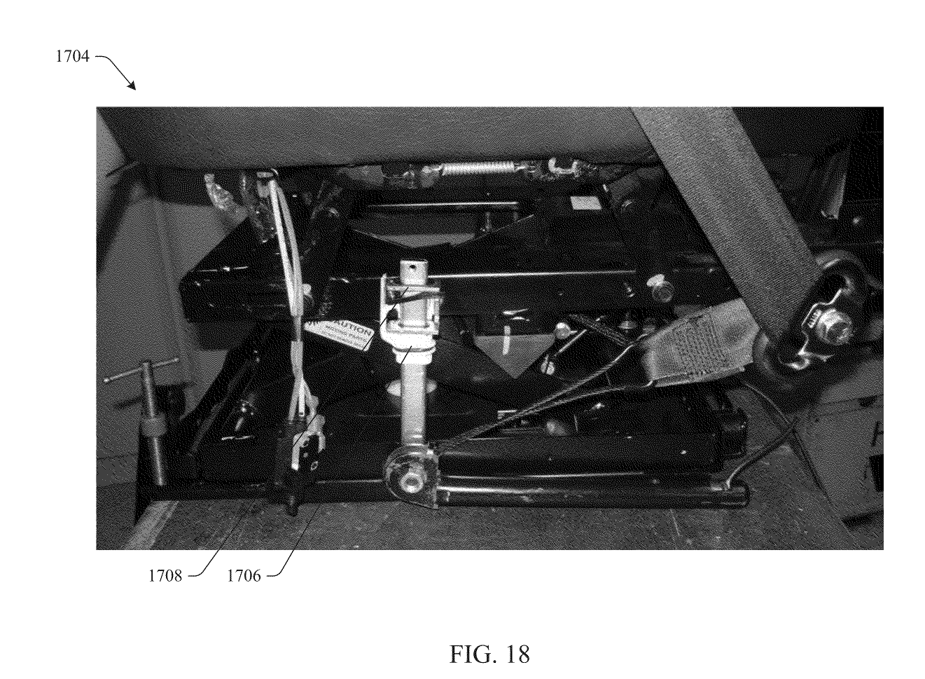

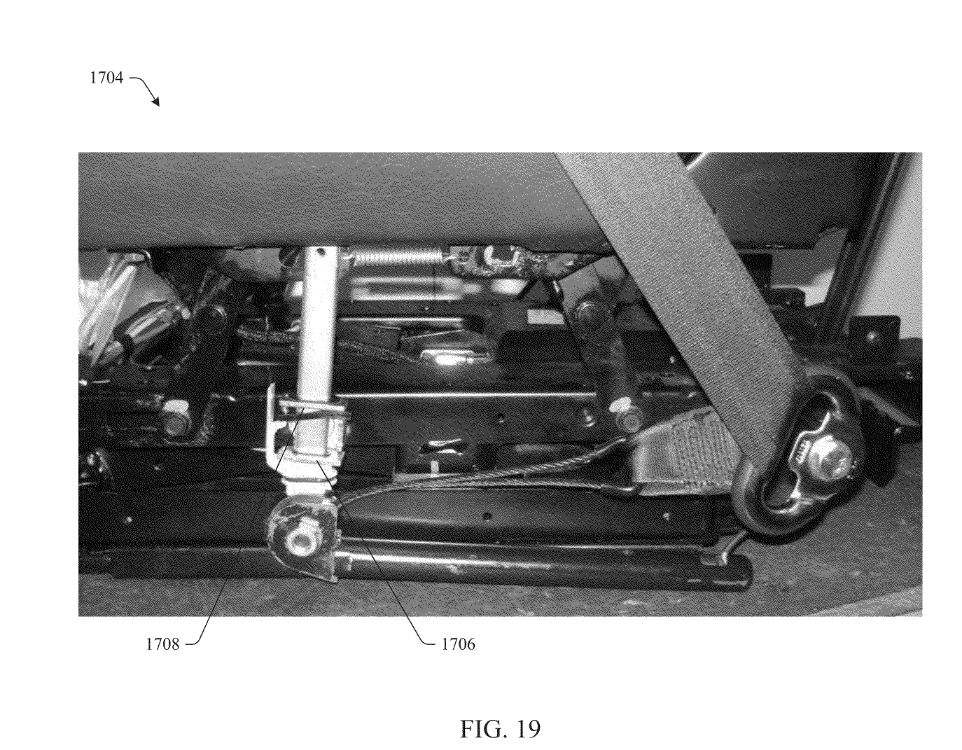

FIGS. 18 and 19 illustrate the seat suspension 1704 in an upper and lower position respectively. The suspension lockout mechanism 1706 communicates and activates a lock plate 1708 in an event (e.g., crash situation) that locks the seat suspension of the seat upon the detection of the event. The lock plate 1708 can be linked to the pyro or other independent source (e.g., 24V switch).

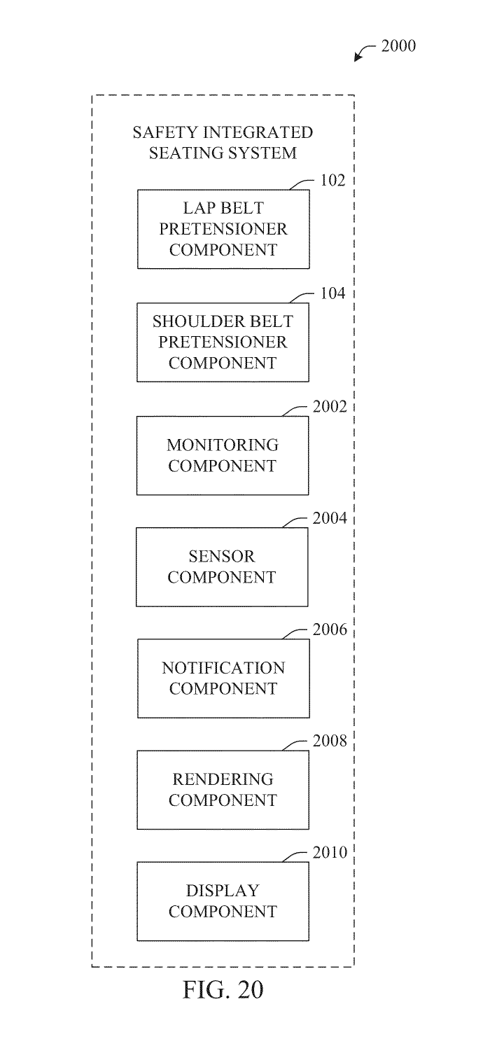

Referring now to FIG. 20, an example block diagram of an SISS in accordance with the innovation is shown. In addition to the lap belt pretensioner and shoulder belt pretensioner components (102, 104), the system 2000 can include a monitoring component 2002, a sensor component 2004, a notification component 2006, a rendering component 2008, and a display component 2010. While the monitor, sensor, rendering, and display components 2002, 2004, 2006, 2008, 2010 are illustrated for use in conjunction with the pretensioner components (102, 104), it is to be understood that this functionality can be employed as a stand-alone system within the scope of this disclosure. Further, it is to be understood that the system can be applied to multi-point harnesses (e.g., 2, 3, 4, 5, etc. point harnesses).

The monitoring component 2002 can be employed to continuously (or periodically) monitor the sensor component 2004 to determine seat occupancy/seat belt status. For example, the monitoring component 2002 monitors to determine if a seat is occupied and, if occupied, if the seat belt is latched. If occupied and not latched, a notification (e.g., audible, vibratory, visual, etc.) can be conveyed (e.g., to an operator) to alert of unsecured passengers. The monitoring component 2002 can also monitor if at any point an occupant disengages their seat belts while travelling and allows the driver to remind the occupant to re-engage their restraint while the coach is in motion. Further, a visual rendering (described below) can be conveyed to the operator.

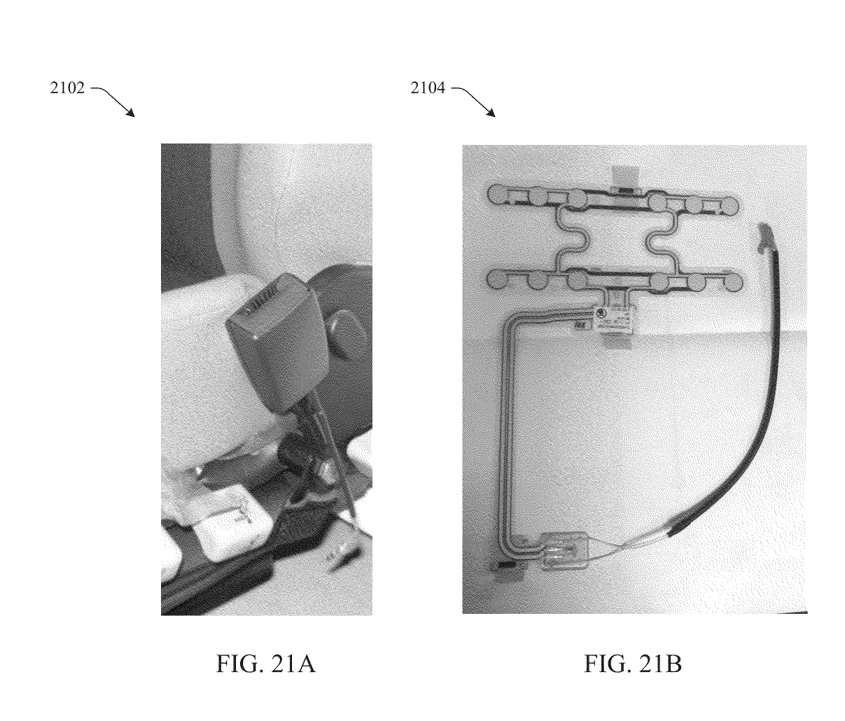

Referring to FIGS. 21A and 21B, the sensor component 2004 can include multiple seat belt buckle mechanism sensors 2102, a seat cushion (upper, lower, etc.) sensors 2104, etc. that senses seat occupancy/seat belt status. For example, a seat belt sensor can be used to determine if a seat belt is latched or unlatched. Further, a seat cushion can be equipped with sensor 2104 to determine if a seat is occupied. This information can be transmitted to the driver via WiFi, Bluetooth, RF, hard wiring, etc.

Power to the sensors and transmission means can be provided by most any power source, such as but not limited to, a PV (photo voltaic) cell mounted on the seat and/or a vibration power unit within the seat, which converts the vibration energy into power which powers a battery. Further, the power can be integrated into the main power source of the vehicle.

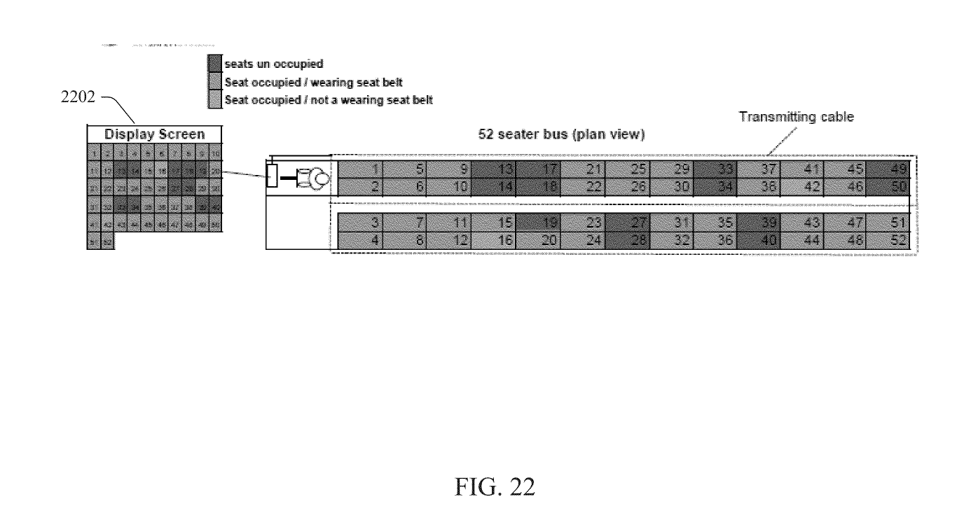

Referring to FIG. 22, the notification component audibly or visually alerts the driver of a disengaged safety belt state when the occupant and the rendering component 2008 provides the seat/seat belt status information for rendering, via an audio or video means. For example, the display component 2010 may include a display 2202 to display the seat/seat belt status information from the rendering component 2008. It is to be appreciated that any type of visual rendering can be employed. For instance, the example embodiment illustrated in FIG. 22 is a color coded scheme whereby the color red indicates that the seat is unoccupied, the color green indicates that the seat is occupied and the seat belt is fastened, and the color orange indicates that the seat is occupied but the seat belt is not fastened.

While the specification describes use innovation in connection with 3- and 4-point harnesses, it is to be understood that the features, functions and benefits can be applied to most any restraint system (e.g., 5-point) without departing from the spirit and/or scope of the innovation described herein. In addition to land vehicle seating (e.g., cars, trucks, construction equipment), the innovation can also be applied in other industries, for example, airlines, watercraft, amusement parks, among others without departing from the scope of this specification.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety integrated seating system (SISS), comprising:
a lap belt pretensioner component that simultaneously cinches two portions of a lap belt upon detection of an event; and
a shoulder belt pretensioner component that simultaneously cinches two shoulder belts upon detection of the event.

2. The SISS of claim 1, further comprising at least one sensing subsystem that detects the event.

3. The SISS of claim 1, wherein the lap belt pretensioner component and the shoulder pretensioner component simultaneously activate upon the detection of the event.

4. The SSIS of claim 1, wherein the lap belt pretensioner includes a lap belt sensing subsystem and the shoulder belt pretensioner includes a shoulder belt sensing subsystem, and wherein at least one of the lap belt sensing subsystem and the shoulder belt sensing subsystem detects the event.

5. The SSIS of claim 4, wherein the lap belt sensing subsystem includes a lap belt sensor that detects the event and a lap belt logic component that determines if the lap belt pretensioner component should be activated upon the detection of an event.

6. The SSIS of claim 4, wherein the shoulder belt sensing subsystem includes a shoulder belt sensor that detects the event and a shoulder belt logic component that determines if the shoulder belt pretensioner component should be activated upon the detection of an event.

7. The SISS of claim 1, further comprising a seat suspension lock that communicates with the sensor subsystem to trigger a lock plate that locks a seat suspension of a seat upon the detection of the event.

8. The SISS of claim 1, further comprising an inflatable airbag integrally disposed within at least one of the portions of the lap belt or at least one of the shoulder belts.

9. A safety integrated seating system (SISS), comprising:
a pretensioning system to pretension a seat belt harness upon a detection of an event;
a sensing subsystem that detects the event and activates the pretensioning system;
a sensor component that senses seat occupancy/seat belt status;
a monitoring component that monitors the sensor component to determine seat occupancy/seat belt status; and
a notification component that alerts of a disengaged safety belt state when the occupant is seated.

10. The SISS of claim 9, wherein the alert is one of vibratory, audible or visual.

11. The SISS of claim 9 further comprising a rendering component that renders the seat occupancy/seat belt status to an operator.

12. The SISS of claim 11 further comprising a display component that displays the seat occupancy/seat belt status on a display.

13. The SISS of claim 9, wherein the sensor component includes at least one seat belt buckle mechanism that senses if a seat belt is attached or deattached.

14. The SISS of claim 9, wherein the sensor component includes a seat cushion sensor disposed in an upper and/or lower portion of a seat, and wherein the seat cushion sensor that determines seat occupancy.

15. The SISS of claim 9, wherein the seat belt harness is a multi-point harness.

16. A method of pretensioning a seat belt harness comprising:
detecting an event via a lap belt sensor and/or a shoulder belt sensor;
determining if a lap belt pretensioner and/or a shoulder belt pretensioner should be activated; and
activating the lap belt pretensioner thereby simultaneously tightening a pair of lap straps and/or the shoulder belt pretensioner thereby simultaneously tightening a pair of shoulder straps.

17. The method of claim 16, wherein determining if a lap belt pretensioner and/or a shoulder belt pretensioner should be activated further comprises determining if the event exceeds a predefined threshold.

18. The method of claim 16, wherein the lap belt pretensioner and the shoulder belt pretensioner are activated independently of each other.

19. The method of claim 16, wherein the lap belt pretensioner and the shoulder belt pretensioner are activated dependently of each other such that when the lap belt pretensioner is activated the shoulder belt pretensioner is subsequently activated or when the shoulder belt pretensioner is activated the lap belt pretensioner is subsequently activated.

20. The method of claim 16, wherein the lap belt pretensioner and the shoulder belt pretensioner are activated simultaneously.
